(19) United States
(12) Patent Application Publication
(10) Pub. No.: US 2022/0005436 A1
(43) Pub. Date: Jan. 6, 2022

(54) DISPLAY CONTROL APPARATUS, DISPLAY CONTROL METHOD, AND DISPLAY CONTROL PROGRAM

(71) Applicant: SONY CORPORATION, Tokyo (JP)

(72) Inventors: Naomasa TAKAHASHI, Chiba (JP); Ken OOTSUKA, Chiba (JP)

(73) Assignee: SONY CORPORATION, Tokyo (JP)

(21) Appl. No.: 17/291,102

(22) PCT Filed: Nov. 20, 2019
(86) PCT No.: PCT/JP2019/045516

§ 371 Date: May 4, 2021

(30) Foreign Application Priority Data
Nov. 27, 2018 (JP) 2018-221719

(51) Int. Cl. G09G 5/10; G06T 7/70; G06T 7/20; G09G 3/00

(52) U.S. Cl. CPC G09G 5/10; G06T 7/70; G06T 7/20; G09G 2360/144; G09G 2320/0261; G09G 2320/0626; G09G 3/002

(57) ABSTRACT

There is provided an apparatus including circuitry configured to control a transmissivity of a transparent screen and a brightness an image projected on the transparent screen, based on characteristics of an environment proximate to the transparent screen.

### CROSS REFERENCE TO RELATED APPLICATIONS

This application claims the benefit of Japanese Priority Patent Application JP 2018-221719 filed Nov. 27, 2018, the entire contents of which are incorporated herein by reference.

### TECHNICAL FIELD

The present disclosure relates to a display control apparatus, a display control method, and a display control program. Specifically, the present disclosure relates to control of image display using a projector.

### BACKGROUND ART

In general, a display such as a liquid crystal monitor is used for image display. Alternatively, instead of the display, a projector that projects an image on a screen or a wall can also be used for image display. Some projectors are ultra-short focus projectors that enable projection from a distance of a few centimeters, for example. Such projectors are capable of performing projection at various places, and thus, it is relatively easy to operate them.

For example, as a technology related to image display, there is known a technology of locally changing the characteristics of a projected image.

### CITATION LIST

### Patent Literature

PTL 1: WO 2016/098600

### SUMMARY

### Technical Problem

In accordance with an existing technology, it is possible to increase the expressive power of the projected image and improve visibility by change characteristics such as luminance and resolution in the target area.

However, in the existing technology, it is difficult to suppress the presence of a display medium such as a screen. In the case of using a projector, there is a need to prepare a wall or screen for projecting an image. Therefore, the presence of the wall or screen increases as an image is displayed on a larger screen although it is not as large as a display case. Note that there are products such as a transparent screen that is usually transparent and displays an image only when light is applied thereto from a projector. Such products have a problem that it becomes difficult to see an image depending on the strength of the ambient light due to being transparent.

Therefore, the present disclosure proposes a display control apparatus, a display control method, and a display control program capable of realizing image display that does not cause a user to feel a sense of oppression while ensuring visibility of an image under external light.

### Solution to Problem

According to an aspect of the present disclosure, there is provided an apparatus including circuitry configured to control a transmissivity of a transparent screen and a brightness an image projected on the transparent screen, based on characteristics of an environment proximate to the transparent screen.

According to another aspect of the present disclosure, there is provided a method including controlling a transmissivity of a transparent screen and a brightness of an image projected on the transparent screen, based on characteristics of an environment proximate to the transparent screen.

According to another aspect of the present disclosure, there is provided a non-transitory computer-readable medium having embodied thereon a program, which when executed by a computer causes the computer to execute a method, the method including controlling a transmissivity of a transparent screen and a brightness of an image projected on the transparent screen, based on characteristics of an environment proximate to the transparent screen.

### BRIEF DESCRIPTION OF DRAWINGS

FIG. 1 is a diagram illustrating an example of display control processing according to a first embodiment of the present disclosure.

FIG. 2 is a diagram illustrating an installation example of the display control apparatus according to the first embodiment of the present disclosure.

FIG. 3 is a diagram illustrating a configuration example of the display control apparatus according to the first embodiment of the present disclosure.

FIG. 4 is a diagram illustrating an example of a data table according to the first embodiment of the present disclosure.

FIG. 5 is a flowchart illustrating a flow of processing according to the first embodiment of the present disclosure.

FIG. 6 is a diagram illustrating an example of display control processing according to a second embodiment of the present disclosure.

FIG. 7 is a diagram illustrating an installation example of the display control apparatus according to the second embodiment of the present disclosure.

FIG. 8 is a diagram illustrating a configuration example of a display control apparatus according to the second embodiment of the present disclosure.

FIG. 9 is a diagram illustrating an example of a data table according to the second embodiment of the present disclosure.

FIG. 10 is a flowchart illustrating a flow of processing according to the second embodiment of the present disclosure.

FIG. 11 is a diagram illustrating a configuration example of a display control system according to an aspect of the present disclosure.

FIG. 12 is a hardware configuration diagram illustrating an example of a computer for realizing a function of the display control apparatus.

### DESCRIPTION OF EMBODIMENTS

Hereinafter, embodiments of the present disclosure will be described in detail on the basis of drawings. Note that in each of the following embodiments, the same part will be denoted by the same reference numeral, thereby omitting redundant description.

The present disclosure will be described in the order of items shown below.

1. First Embodiment

1-1 One example of display control processing according to first embodiment

1-2 Configuration example of display control apparatus according to first embodiment

1-3 Procedure of display control processing according to first embodiment

1-4 Modification according to first embodiment

2. Second Embodiment

2-1 One example of display control processing according to second embodiment

2-2 Configuration example of display control apparatus according to second embodiment

2-3 Procedure of display control processing according to second embodiment

2-4 Modification according to second embodiment

3. Other embodiments

3-1 One example of display control system according to present disclosure

3-2 Other

4. Effect of display control apparatus according to present disclosure

5. Hardware configuration

### 1. First Embodiment

### 1-1. One Example of Display Control Processing According to First Embodiment

In the present disclosure, a description will be given of a display control apparatus 100 that enables image display that does not cause a user to feel a sense of oppression while ensuring visibility of an image under external light.

In general, there is a need for a larger screen for an apparatus (display medium) for displaying an image. A display employing a system such as a liquid crystal display (LCD) and an organic light emitting diode (OLED) is used for image display. However, when trying to realize a larger screen with a display employing a system such as an LCD and OLED, the entire case becomes large and heavy. This can be a factor that causes the user to feel a sense of oppression.

A transparent display is mentioned as a proposal for enabling image display that does not cause a user to feel a sense of oppression. The transparent display can be realized by a known system such as the LCD and the OLED. However, in the LCD or OLED system, structurally, it is difficult to avoid light being blocked by a semiconductor circuit around a light emitting section, and it is difficult to increase transparency (transmittance). In addition, since the display of the LCD or OLED system has fixed pixels, there is a problem that a size and resolution of a screen are fixed. Furthermore, the display of the LCD or OLED system has limitations in increasing the screen size in terms of productions facilities and the like.

In view of the above point, there is a proposal to display an image by combining a projector and a screen instead of the transparent display. For example, by using a simple configuration in which an ultra-short focus projector is installed directly under the screen, it is possible to display a larger image as compared with the display of the LCD or OLED system. In addition, the projector has an advantage of being able to flexibly set a size and resolution of an image to be projected. However, even when such a configuration is adopted, since a configuration such as the screen and white-based wall for projection may be necessary, a sense of presence of a display medium such as the screen and wall is given in a state in which the user does not view the image.

Incidentally, there is a transparent screen is as an example of a screen on which the projector performs projection. For example, the transparent screen is configured to enclose a substance that diffuses light with a substance having a high transmittance. The transparent screen is normally transparent. However, the transparent screen is capable of displaying, when an image, etc. is projected, the projected image thereon, by reflecting light at a specific angle. In accordance with the transparent screen, since it is difficult to cause the user to feel a sense of presence when the image is not projected, it is possible to prevent the user from feeling a sense of oppression by installation of the screen.

However, the transparent screen having high transmittance is susceptible to ambient light such as external light. For this reason, in the above configuration, even if it is possible to display an image in a dark room, etc., there is concern that visibility of the image may extremely deteriorate under external light. Meanwhile, when black coating, etc. is performed on a screen surface in an attempt to suppress an influence of ambient light, the transmittance of the screen decreases.

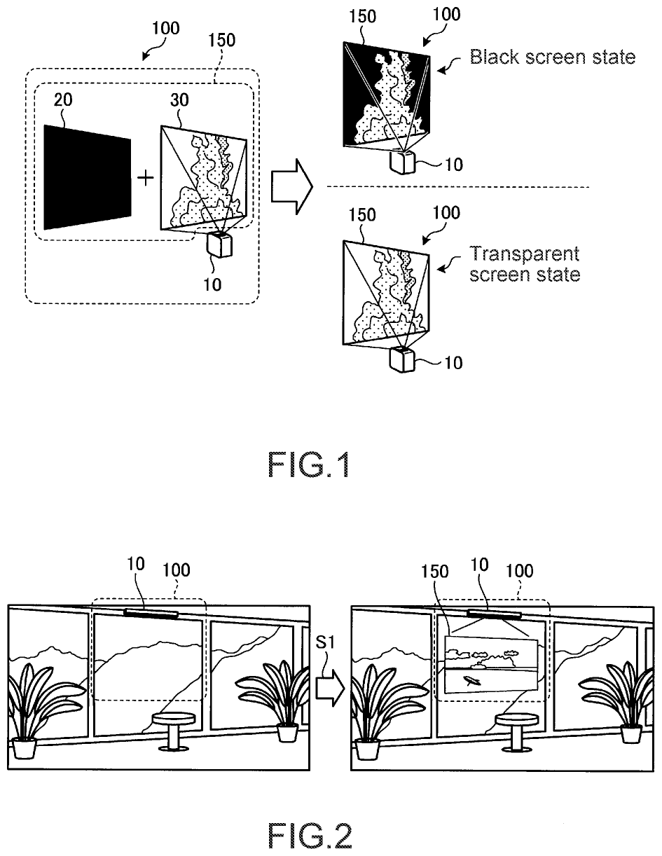

As described above, in image display, various problems are present to enable image display that does not cause the user to feel a sense of oppression while ensuring visibility of the image under external light. The display control apparatus 100 according to an embodiment of the present disclosure solves the above-mentioned problems by a configuration and display control processing described below. Hereinafter, an example of the configuration of the display control apparatus 100 according to an embodiment of the present disclosure and display control processing will be described using FIG. 1 and FIG. 2.

FIG. 1 is a diagram illustrating an example of display control processing according to the first embodiment of the present disclosure. Display control processing according to the first embodiment of the present disclosure is performed by the display control apparatus 100 illustrated in FIG. 1.

In the first embodiment, the display control apparatus 100 includes, as components, a projector 10 having a function of projecting an image, and a display section 150 that displays the image projected from the projector 10. The display control apparatus 100 is an information processing apparatus that controls projection of an image of the projector 10 and a display mode of the display section 150.

Although not illustrated in FIG. 1, in the first embodiment, for example, the display control apparatus 100 is realized as a mode such as a microchip incorporated in the projector 10 or the display section 150. Specifically, even though the display section 150 and the projector 10 are described as individual devices in an example of FIG. 1 to facilitate understanding of description, the display control apparatus 100 may be configured as one housing in which the display section 150 and the projector 10 are integrated.

Note that the display control apparatus 100 may have any mode as long as the display control apparatus 100 can control the projector 10 and the display section 150 by wire or wirelessly. For example, the display control apparatus 100 may correspond to a smartphone, a tablet terminal, etc. In this case, display control processing according to an embodiment the present disclosure may be realized as one function of an application installed in a smartphone, a tablet terminal, etc.

The projector 10 is a device that projects image data, etc. In the first embodiment, the projector 10 is referred to as a so-called ultra-short focus projector, and can project an image on a medium several centimeters to several tens of centimeters ahead.

Note that in the example of FIG. 1, the projector 10 and the display section 150 are spatially separated from each other. However, the projector 10 may be integrated with the display section 150. For example, the projector 10 may be embedded in a lower or upper bezel portion (edge) of the display section 150.

The display section 150 includes a light control film 20 and a transparent screen 30. For example, the display section 150 is configured by bonding the light control film 20 and the transparent screen 30.

The light control film 20 is a film whose transmittance is variable by voltage or current control. For example, the light control film 20 is a film configured by interposing an electrochromic element between transparent electrodes, and has a light control function of an electrochromic system. In the electrochromic system, the transmittance of the film is controlled by occurrence of an oxidation reaction or a reduction reaction in the electrochromic element in accordance with a voltage applied to the transparent electrode. Note that a suspended particle device (SPD) method, a gas chromic method, etc. may be employed for the light control film 20.

That is, the light control film 20 can freely change the transmittance by electronic control. For example, in the first embodiment, the light control film 20 is transparent (a shading rate is the lowest) when the transmittance is maximized, and black (the shading rate is the maximum) when the transmittance is minimized.

The transparent screen 30 is a screen formed of a transparent material and a material that diffuses light. For example, in a case where the transparent screen 30 receives light projected from the projector 10 installed at a lower side or an upper side, a transparent material portion transmits the light, and a material portion that diffuses light diffuses (reflects) light. Specifically, in a case of receiving light projected from the projector 10, the transparent screen 30 reflects light on a viewing surface, i.e., a front face of the transparent screen 30. In this way, the transparent screen 30 can display the image projected from the projector 10 while maintaining permeability.

As described above, the display control apparatus 100 can perform image display that does not cause a user to feel a sense of oppression, by using the display section 150 formed of a transparent member as a display surface of the image. In addition, the display control apparatus 100 can improve visibility of the image by controlling the transmittance of the light control film 20 and setting of an image signal projected by the projector 10.

For example, the display control apparatus 100 detects ambient light around the display section 150 using an illuminance sensor embedded in the display section 150. Specifically, the display control apparatus 100 detects a numerical value of an illuminance around the display section 150 (hereinafter collectively referred to as ┌environment information┘).

Further, in a case where an extremely strong illuminance of external light, etc. is observed in the vicinity of the display section 150, the display control apparatus 100 performs a control operation such that the light control film 20 is in a light shielding state. In the example of FIG. 1, when the light control film 20 is in the light shielding state, the light control film 20 is black, and thus the display section 150 is in a black screen state. If the display section 150 is in the black screen state, the image projected from the projector 10 is clearly displayed when compared to a state in which the transmittance is high. That is, the display control apparatus 100 can improve visibility of the image.

Meanwhile, in a case where an extremely strong illuminance of external light, etc. is not observed in the vicinity of the display section 150, the display control apparatus 100 performs a control operation such that the light control film 20 is in a transmissive state. In the example of FIG. 1, when the light control film 20 is in the transmissive state, the light control film 20 is transparent, and thus the display section 150 is in a transparent screen state. If the display section 150 is in the transparent screen state, the image projected from the projector 10 is displayed on a transparent member. For this reason, the display control apparatus 100 can provide the user with a fresh image experience in which an image is displayed in space. In addition, in the transparent screen state, a sense of presence of the display section 150 can be relatively prevented from being felt by the user when compared to the black screen state.

Next, a description will be given of an installation example of the display control apparatus 100 using FIG. 2. FIG. 2 is a diagram illustrating an installation example of the display control apparatus 100 according to the first embodiment of the present disclosure.

As illustrated in FIG. 2, the display control apparatus 100 is installed as, for example, a window glass of a house. In the example illustrated in FIG. 2, the display control apparatus 100 (more specifically, the display section 150 related to the display control apparatus 100) may correspond to the entire window glass or a part of the window glass. Further, the projector 10 related to the display control apparatus 100 is installed in the upper part of the window glass, for example. Note that for example, the projector 10 may be installed on a floor surface, or may be embedded in an edge of the window glass.

The display section 150 related to the display control apparatus 100 is transparent in a state in which an image is not displayed, and thus does not block the field of view from the inside to the outside of the room. That is, the user can handle the display control apparatus 100 in the same mode as a normal window glass.

After that, in the case of receiving an operation of image display from the user, the display control apparatus 100 starts processing of displaying an image (Step S1). At this time, the display control apparatus 100 acquires environment information around the display section 150 by using an illuminance sensor or the like. Then, the display control apparatus 100 controls the light shielding state of the display section 150 in accordance with the environment information. Specifically, in the case where the display section 150 is exposed to extremely strong light such as external light, the display control apparatus 100 performs a control operation such that the display section 150 is in a light shielding state. For example, the display control apparatus 100 changes the state of the display section 150 to the light shielding state by controlling voltage or the like to be applied to the light control film 20.

Further, the display control apparatus 100 may also control the image signal projected from the projector 10 in accordance with the environment information. For example, in the case where the display section 150 is exposed to external light, the display control apparatus 100 switches the mode of the image signal projected by the projector 10 to an image mode (e.g., image mode referred to as so-called ┌vivid (high luminance, high contract, and high color temperature)┘, etc.) in which the outline of the image is sharper.

As a result, the display control apparatus 100 can provide the user with a clear image with high contrast even under the influence of external light.

Note that in the case where the environment illuminance value is relatively low, the display control apparatus 100 may maintain the display section 150 in a transmissive state. In this case, the display control apparatus 100 may also switch the mode of the image signal projected by the projector 10 to an image mode (e.g., image mode referred to as so-called ┌Standard (standard setting)┘ or ┌film (low luminance and low color temperature as in a cinema)┘ that makes it possible to naturally view the image. For example, the display control apparatus 100 stores such setting of the light shielding state and image signal in a database in advance, and refers to the database to control the light shielding state and the image signal. Further, regarding the setting of the light shielding state and image signal, the display control apparatus 100 may receive setting of the numerical value and state desired by the user in advance.

That is, the display control apparatus 100 can display an image while maintaining the permeability of the display section 150 depending on the environment. As a result, the display control apparatus 100 can provide the user with a fresh image experience as if the outside scenery and the image are mixed.

As described above, the display control apparatus 100 controls, on the basis of the environment information, pixel information of an image of projected on the transparent screen 30 related to the display section 150 and transmittance of the light control film 20 related to the display section 150. Specifically, the display control apparatus 100 adjusts the transmittance of the display section 150 in accordance with the illuminance around the display control apparatus 100, and switches the setting of the image signal. As a result, the display control apparatus 100 can balance the image to be displayed while maintaining the functionality as a window glass. For example, in accordance with the display control apparatus 100, the user can enjoy a clear image on a large screen without installing a case of a large display or the like in a room. Further, since the user can use, for image display, a window glass or the like that may be necessary for housing equipment without newly installing a screen or the like, space can be effectively used. As described above, the display control apparatus 100 can realize image display that does not cause a user to feel a sense of oppression while ensuring visibility of an image under external light.

In addition, the display control apparatus 100 projects an image by the projector 10, and thus can flexibly change a size of the image and a place where the image is projected. Even though FIG. 2 illustrates an example in which an image is projected on a part of the window glass (display section 150), the display control apparatus 100 may display the image on the entire window glass. In addition, the display control apparatus 100 may perform processing for improving visibility of an image in accordance with a projection position, such as shielding only an area where an image is projected from light.

In addition, the display control apparatus 100 may identify a position presumed to be an obstacle to viewing an image, such as a direct spot of the sun and a position corresponding to strong reflection on the basis of the illuminance sensor, and project the image while avoiding the identified position. Alternatively, the display control apparatus 100 may identify a position of a high luminance point where strong light is observed, and perform a control operation to project an image on a place where the user does not need to visually recognize the position.

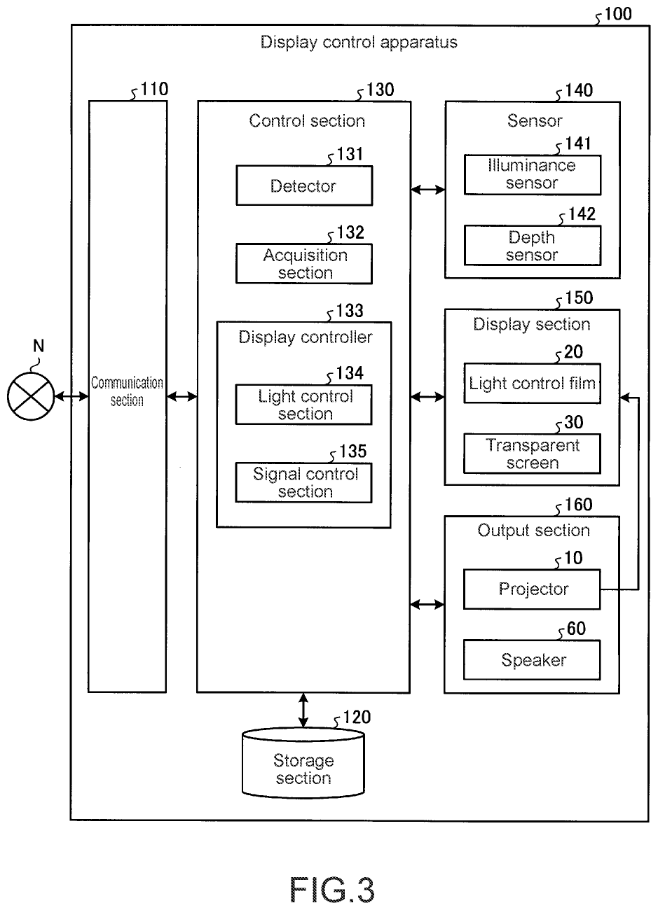

Hereinafter, a description will be given of a configuration of the display control apparatus 100, etc. according to the first embodiment using FIG. 3 and subsequent figures.

### 1-2. Configuration Example of Display Control Apparatus According to First Embodiment

The configuration of the display control apparatus 100 will be described using FIG. 3. FIG. 3 is a diagram illustrating a configuration example of the display control apparatus 100 according to the first embodiment of the present disclosure. As illustrated in FIG. 3, the display control apparatus 100 includes a communication section 110, a storage section 120, a control section 130, a sensor 140, the display section 150, and an output section 160.

Note that the configuration illustrated in FIG. 3 is a functional configuration, and a hardware configuration may be different therefrom. In addition, functions of the display control apparatus 100 may be distributed and implemented in a plurality of physically separated devices. For example, the display control apparatus 100 may be separated into the display section 150 corresponding to a display medium, the projector 10, and a control device that controls the display section 150 and the projector 10.

The communication section 110 is realized by, for example, a network interface card (NIC). The communication section 110 may correspond to a universal serial bus (USB) interface including a USB host controller, a USB port, etc. Alternatively, the communication section 110 may correspond to a high-definition multimedia interface (HDMI) (registered trademark) interface, etc. for receiving an input of an image file projected by the projector 10. Alternatively, the communication section 110 may correspond to a wired interface or a wireless interface. For example, the communication section 110 may correspond to a wireless communication interface of a wireless local area network (LAN) method or a cellular communication method. The communication section 110 functions as communication means or transmission means of the display control apparatus 100. For example, the communication section 110 is connected to a network N (such as the Internet) by wire or wirelessly, and transmits and receives information to and from another information processing terminal, etc. via the network N. For example, the communication section 110 may receive an operation from the user or an input of various types of information via the network N.

The storage section 120 is realized by, for example, a semiconductor memory device such as a random access memory (RAM) and a flash memory, or a storage device such as a hard disk and an optical disc. The storage section 120 stores various data.

For example, the storage section 120 stores a data table DB01 in which information about a scheme of controlling the transmittance or the image in accordance with the environment information is set.

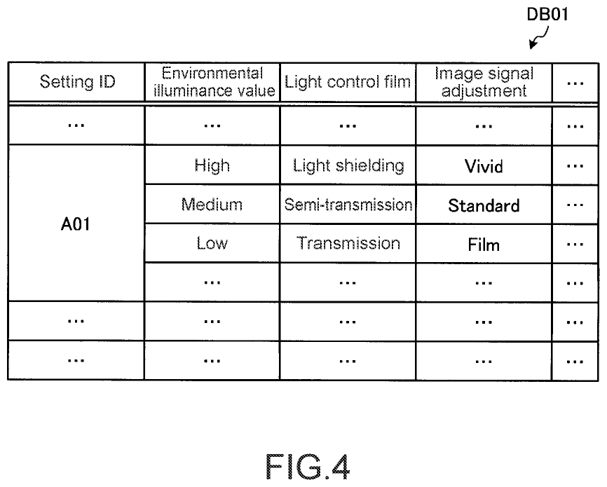

FIG. 4 illustrates an example of the data table DB01 according to the first embodiment. FIG. 4 is a diagram illustrating an example of the data table DB01 according to the first embodiment of the present disclosure. In the example illustrated in FIG. 4, the data table DB01 has items such as ┌setting ID┘, ┌environmental illuminance value┘, ┌light control film┘, and ┌image signal adjustment┘.

┌Setting ID┘ indicates identification information for identifying setting information. ┌Environmental illuminance value┘ indicates an illuminance value in the environment information detected by the display control apparatus 100. Note that even though relative information such as ┌high┘, ┌medium┘, and ┌low┘ is stored in an item of the environmental illuminance value in the example of FIG. 4, a specific numerical value may be stored in the item of the environmental illuminance value. For example, an item ┌high┘ in the environmental illuminance value is a numerical value corresponding to daytime external light. In addition, an item ┌medium┘ in the environmental illuminance value is a numerical value corresponding to, for example, external light in the early morning or the evening. In addition, an item ┌low┘ in the environmental illuminance value is a numerical value corresponding to, for example, external light at night.

┌Light control film┘ indicates the transmissive state of the light control film 20. Even though FIG. 4 shows an example in which relative information such as ┌light shielding┘, ┌semi-transmission┘, and ┌transmission┘ is stored in an item of light control film, a specific numerical value (transmittance) may be stored in an item of the light control film.

┌Image signal adjustment┘ indicates setting information of an image signal projected from the projector 10. Even though FIG. 4 shows an example in which an image mode name such as ┌vivid┘, ┌standard┘, and ┌film┘ is stored in an item of the image signal adjustment, a specific numerical value (pixel information) such as luminance, contrast, and color temperature may be stored in an item of image signal adjustment.

That is, in the example illustrated in FIG. 4, as an example of setting information identified by a setting ID ┌A01┘, when environmental illuminance value corresponds to ┌high┘, the light control film is controlled to ┌light shielding┘, and the image signal is adjusted to the image mode ┌vivid┘.

Returning to FIG. 3, the description will be continued. For example, the control section 130 is realized when a program (for example, a display control program according to an embodiment the present disclosure) stored in the display control apparatus 100 is executed with a RAM or the like as a work area by a central processing section (CPU), a micro processing section (MPU), a graphics processing section (GPU), etc. In addition, the control section 130 is a controller, and may be realized by, for example, an integrated circuit such as an application specific integrated circuit (ASIC) and a field programmable gate array (FPGA).

As illustrated in FIG. 3, the control section 130 includes a detector 131, an acquisition section 132, and a display controller 133, and implements or executes a function or an action of information processing described below. Note that an internal configuration of the control section 130 is not limited to the configuration illustrated in FIG. 3, and may correspond to another configuration when the configuration performs information processing described below.

The detector 131 detects various types of information by controlling the sensor 140. For example, the detector 131 detects environment information indicating an environment around the display control apparatus 100 or the display section 150.

The sensor 140 is a device that detects various types of information regarding the display control apparatus 100. For example, the sensor 140 includes an illuminance sensor 141 and a depth sensor 142.

The illuminance sensor 141 is referred to as an ambient light sensor, etc., and is a device that detects an ambient illuminance using a phototransistor, a photodiode, etc.

The depth sensor 142 is a device that detects a distance to a target object to estimate a shape of the target object or detect motion of the target object on the basis of the distance. The depth sensor 142 may correspond to any one of a time of flight (ToF) method, a stereo camera method, a structured-light (SL) method, an infrared method, etc. For example, the depth sensor 142 detects information such as a distance to the user viewing an image and motion of the user.

Note that the sensor 140 illustrated in FIG. 3 is an example, and the display control apparatus 100 may include various sensors for detecting numerical values (for example, temperature, humidity, altitude, etc.) indicating the environment information. In addition, the sensor 140 may include a sensor for tracking a direction of the sight line of the user or movement of the sight line in the information regarding the motion of the user.

The acquisition section 132 acquires various types of information. For example, the acquisition section 132 acquires the environment information detected by the detector 131. Specifically, the acquisition section 132 acquires environment information around the display section 150 that includes the transparent screen 30 for reflecting the image projected from the projector 10 and the light control film 20 having a variable transmittance.

For example, the acquisition section 132 acquires an illuminance around the display section 150, which is detected by the illuminance sensor 141 provided in the vicinity of the display section 150.

Further, the acquisition section 132 acquires information regarding action of a user around the display section 150, which is detected by the depth sensor 142. Note that the user around the display section 150 indicates, for example, a user whose distance to the display section 150 or the like can be measured by the depth sensor 142.

The acquisition section 132 appropriately stores the acquired information in the storage section 120. In addition, the acquisition section 132 may appropriately acquire information for processing from the storage section 120. In addition, the acquisition section 132 may acquire information from various external devices via the network N.

The display controller 133 controls the pixel information of the image to be projected on the transparent screen 30 and the transmittance of the light control film 20 on the basis of the environment information.

For example, the display controller 133 refers to the data table DB01 to control the pixel information of the image and the transmittance of the light control film on the basis of setting information in which the illuminance as an example of the environment information, the pixel information of the image, and the transmittance of the light control film are associated with each other in advance.

As an example, the display controller 133 performs a control operation such that as the illuminance is higher, the transmittance of the light control film is lower, and a luminance value of the pixel of the image is higher. In this way, the display controller 133 can display a clear image even under a condition of a high illuminance such as external light. As illustrated in FIG. 3, the display controller 133 includes a light control section 134 and a signal control section 135, and executes each of the above-described processes by controlling the light control section 134 and the signal control section 135.

The light control section 134 controls the transmittance of the light control film. For example, the light control section 134 controls the transmittance of the light control film in accordance with the illuminance around the display section 150. Specifically, the light control section 134 controls a voltage or current value applied to the light control film 20 so that the transmittance of the light control film 20 becomes a set value corresponding to the illuminance with reference to the data table DB01.

The signal control section 135 is a so-called video processor, and controls the pixel information of the image to be projected on the transparent screen 30. For example, the signal control section 135 controls the pixel information of the image to be projected on the transparent screen 30 in accordance with the illuminance around the display section 150. Specifically, the signal control section 135 controls the output value of the image signal to obtain pixel information corresponding to the illuminance with reference to the data table DB01. For example, the signal control section 135 controls the output value of the image signal so that the luminance, the contrast, the color temperature, etc. in the image signal become set values according to the illuminance.

The display section 150 is a display medium for displaying the image projected from the projector 10. As illustrated in FIG. 3, the display section 150 includes the light control film 20 and the transparent screen 30.

The output section 160 is a device for outputting various types of information. As illustrated in FIG. 3, the output section 160 includes the projector 10 and a speaker 60. The projector 10 projects an image signal on the display section 150 on the basis of an image signal set by the display controller 133. The speaker 60 outputs an audio signal in an image file acquired by the acquisition section 132 and an image file stored in the storage section 120.

### 1-3. Procedure of Display Control Processing According to First Embodiment

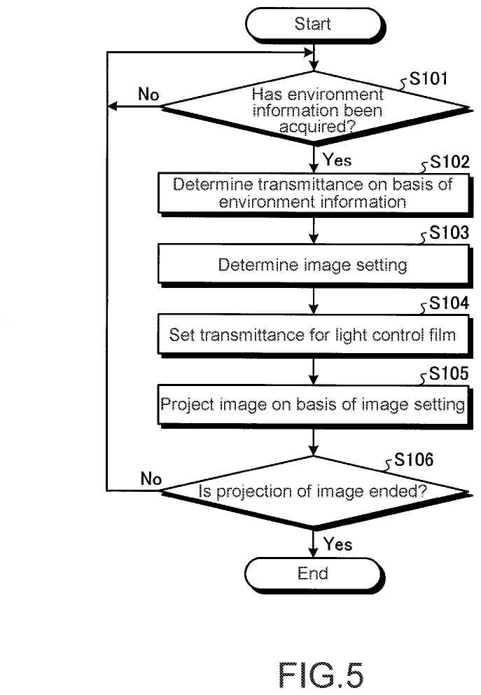

Next, a description will be given of a procedure of image processing according to the first embodiment using FIG. 5. FIG. 5 is a flowchart illustrating a flow of processing according to the first embodiment of the present disclosure.

As illustrated in FIG. 5, the display control apparatus 100 determines whether environment information has been acquired (step S101). When the environment information has not been acquired (step S101; No), the display control apparatus 100 controls the sensor 140 and repeats a process for acquiring the environment information.

When the environment information has been acquired (step S101; Yes), the display control apparatus 100 determines the transmittance of the light control film 20 on the basis of the environment information (Step S102).

In addition, the display control apparatus 100 determines setting of the image signal output from the projector 10 on the basis of the environment information (step S103).

Subsequently, the display control apparatus 100 sets the transmittance determined in step S102 for the light control film 20 (step S104). Specifically, the display control apparatus 100 causes transition of the transmittance of the light control film 20 by controlling the light control film 20 on the basis of a parameter (a voltage value, etc.) for changing the light control film 20 to the transmittance determined in step S102.

In addition, the display control apparatus 100 projects the image on the display section 150 on the basis of image setting by controlling the projector 10 using image setting determined in step S103 (step S105).

Thereafter, the display control apparatus 100 determines whether an operation to end projection of the image has been received from a user (step S106). When the operation to end projection of the image has not been received from the user (step S106; No), the display control apparatus 100 repeats a process of acquiring the environment information, and continues adjusting the transmittance and image setting to obtain appropriate image display in accordance with the environment information. Meanwhile, when the operation to end projection of the image has been received from the user (step S106; Yes), the display control apparatus 100 ends projection of the image.

### 1-4. Modification According to First Embodiment

The display control apparatus 100 according to the first embodiment may include a projector having a general focal length as well as the ultra-short focus projector as the projector 10. In addition, the display control apparatus 100 may receive light control and image setting operation from a terminal device such as a smartphone used by the user using, for example, a Wi-Fi (registered trademark) or a Bluetooth (registered trademark) function.

### 2. Second Embodiment

### 2-1. One Example of Display Control Processing According to Second Embodiment

A display control apparatus 200 according to a second embodiment includes a display section 250. The display section 250 further includes a light control mirror 40 in addition to the light control film 20 and the transparent screen 30. Hereinafter, a description will be given of display control processing performed by the display control apparatus 200 according to the second embodiment. Note that a description overlapping with the first embodiment will be omitted.

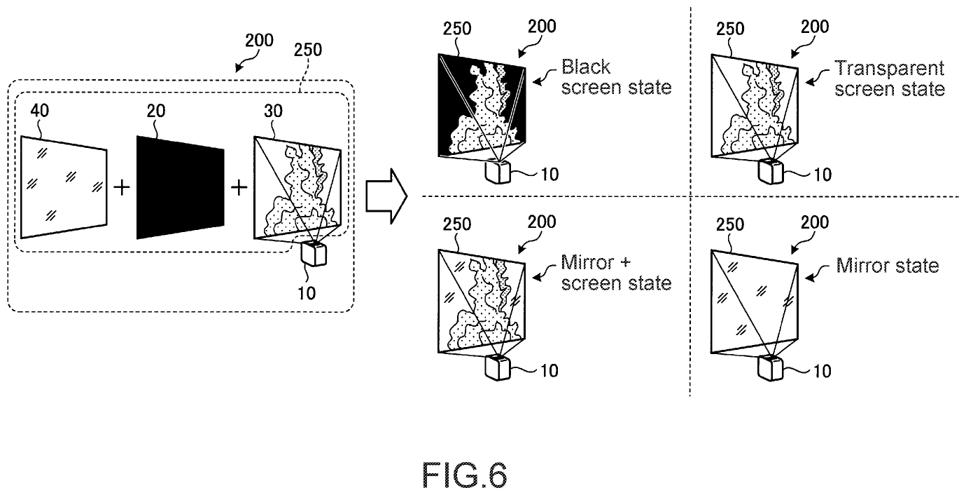

FIG. 6 is a diagram illustrating an example of display control processing according to the second embodiment of the present disclosure. Display control processing according to the second embodiment of the present disclosure is performed by the display control apparatus 200 illustrated in FIG. 6.

As illustrated in FIG. 6, the display section 250 according to the second embodiment includes the light control film 20, the transparent screen 30, and the light control mirror 40. For example, the display section 250 is configured by bonding the light control film 20, the transparent screen 30, and the light control mirror 40.

The light control mirror 40 is configured, for example, by interposing an electrochromic element between transparent electrodes. The light control mirror 40 can switch between a mirror state and a transparent state by electronic control.

The display control apparatus 200 according to the second embodiment can perform various types of image display by controlling the transmittance of the light control mirror 40 in addition to the light control film 20 and the transparent screen 30.

For example, the display control apparatus 200 can obtain a state in which operation as a screen is allowed while displaying a mirror in addition to the black screen state and the transparent screen state described in the first embodiment by controlling the transmittance of the display section 250. Such a state is indicated as a ┌mirror+screen state┘ in the example of FIG. 6. In the mirror+screen state, the display control apparatus 200 can further superimpose and display an image on the display section 250 in the mirror state.

In addition, the display control apparatus 200 can put the display section 250 in the mirror state by allowing the light control film 20 to be penetrated and controlling the light control mirror 40 in the mirror state. In this way, the display control apparatus 200 can provide the user with the display section 250 as a mirror when an image is not projected.

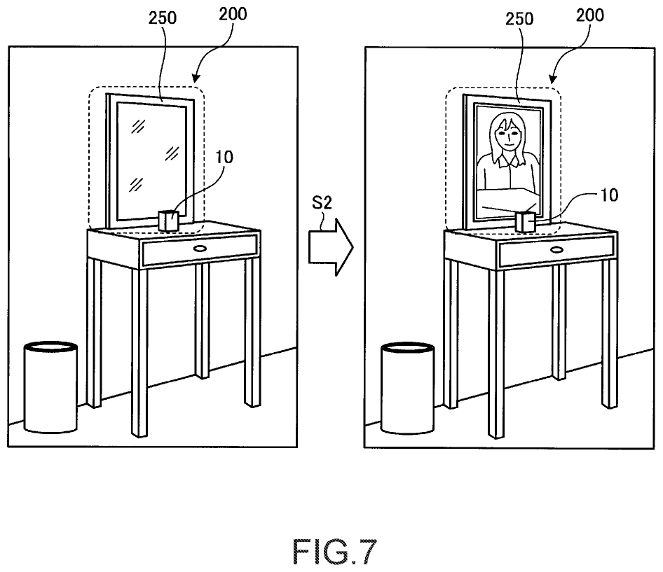

Next, an installation example of the display control apparatus 200 will be described using FIG. 7. FIG. 7 is a diagram illustrating an installation example of the display control apparatus 200 according to the second embodiment of the present disclosure.

As shown in FIG. 7, the display control apparatus 200 may be installed as, for example, a vanity mirror. The projector 10 related to the display control apparatus 200 is installed, for example in a lower portion of the vanity mirror. Note that, for example, the projector 10 may be installed on a floor surface, or may be embedded in an edge of the vanity mirror.

The display section 250 related to the display control apparatus 200 is in a mirror state when an image is not displayed. That is, the user can handle the display control apparatus 200 in the same mode as that of the vanity mirror.

Thereafter, in a case of receiving an image display operation from the user, the display control apparatus 200 starts a process of displaying an image (step S2). In this instance, for example, the display control apparatus 200 allows the light control mirror 40 to be transmissive to release the mirror state. In this way, the display section 250 functions as not a mirror but a screen for displaying an image. That is, the user can view an image using a mirror installed on a dressing table. Specifically, the user can cause the display control apparatus 200 to display image content corresponding to an example of makeup of the user. In this instance, as in the first embodiment, the display control apparatus 200 may adjust the transmittance of the light control film 20 and the image signal in accordance with the environment information to improve the visibility of the image.

In addition, the display control apparatus 200 may perform a process to switch between the mirror state and the transmissive state in accordance with an operation of the user or motion of the user.

For example, in the example illustrate in FIG. 7, it is presumed that the user performs makeup of the user while displaying image content corresponding to a sample of makeup prepared in advance. In this case, when the user desires to display a face of the user on a mirror while displaying the image content, the user sets the light control mirror 40 in a semi-transmissive state. In the way, the user can check the face of the user on the mirror while displaying the image content.

In addition, the display control apparatus 200 may automatically change a display state of the screen without receiving an operation from the user. For example, the display control apparatus 200 acquires motion information of the user using the depth sensor 142 installed at the edge, etc. of the display section 250. Specifically, the display control apparatus 200 acquires motion of the user or position information such as whether the user is directly facing the display section 250 or obliquely viewing the display section 250. Alternatively, the display control apparatus 200 may observe movement, etc. of the head of the user on the basis of tracking information obtained by the depth sensor 142.

Further, for example, when the user is positioned directly in front of the display section 250, the display control apparatus 200 temporarily suspends projection from the projector 10 so that the user can use the mirror. In addition, for example, when the user obliquely looks into the display section 250, the display control apparatus 200 makes the display section 250 semi-transparent, starts projection from the projector 10, and displays an image.

In this way, the user can use the mirror when the user performs makeup and occasionally check the image content of the sample by performing an operation of slightly moving the head sideways, etc. In addition, for example, when the user moves the head upward or downward with respect to the display section 250, the display control apparatus 200 may completely shield the light control film 20 from light and start projection from the projector 10. In this way, the display control apparatus 200 can display a clearer image in accordance with specific motion of the user. That is, the display control apparatus 200 can appropriately change setting of the display section 250 or the projector 10 in accordance with various types of motion of the user.

As described above, the display control apparatus 200 can display an image while maintaining permeability of the display section 250 in a manner that depends on the environment. In this way, the display control apparatus 200 can provide the user with a fresh image experience as if the outside scenery and the image are mixed.

As described above, the display control apparatus 200 controls pixel information of an image to be projected on the transparent screen 30 related to the display section 250, the transmittance of the light control film 20 related to the display section 250, and the transmittance of the light control mirror 40 on the basis of the environment information. In addition, the display control apparatus 200 may adjust the transmittance of the display section 250 in accordance with the motion of the user as well as the ambient illumination, etc. In this way, the display control apparatus 200 can perform highly convenient image display such as displaying an image by superimposing the image on a mirror while maintaining functionality as the mirror.

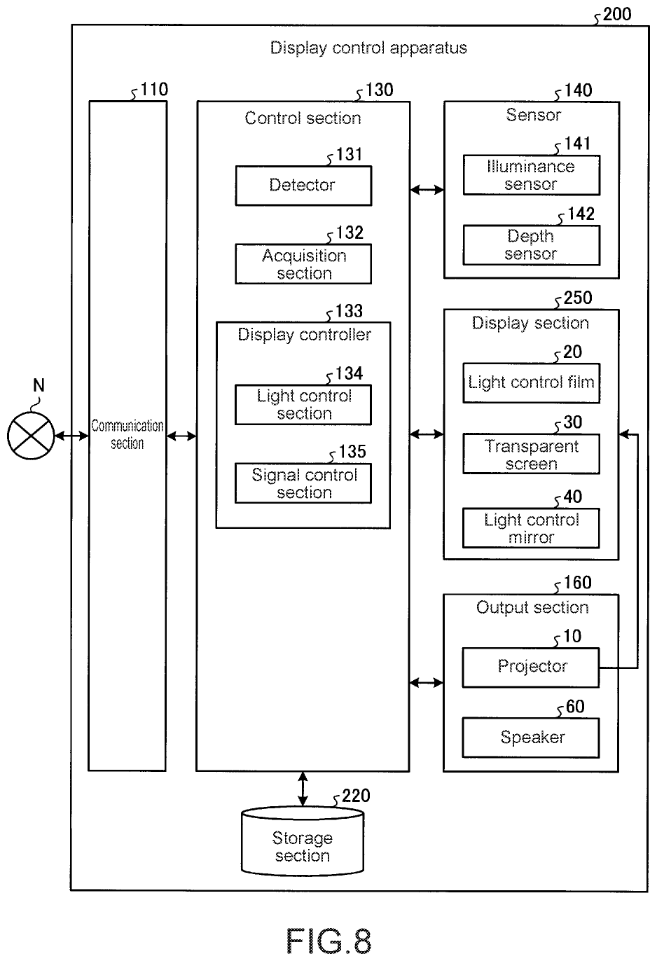

Hereinafter, a description will be given of a configuration of the display control apparatus 200, etc. according to the second embodiment using FIG. 8 and subsequent figures.

### 2-2. Configuration Example of Display Control Apparatus According to Second Embodiment

A description will be given of the configuration of the display control apparatus 200 using FIG. 8. FIG. 8 is a diagram illustrating a configuration example of the display control apparatus 200 according to the second embodiment of the present disclosure. As illustrated in FIG. 8, the display control apparatus 200 is different from the first embodiment in that the display control apparatus 200 has the display section 250 including the light control mirror 40 and a storage section 220.

In addition to the information held by the storage section 120 according to the first embodiment, the storage section 220 stores a data table DB02 in which information about a scheme of controlling the transmittance and image in accordance with motion of the user is set.

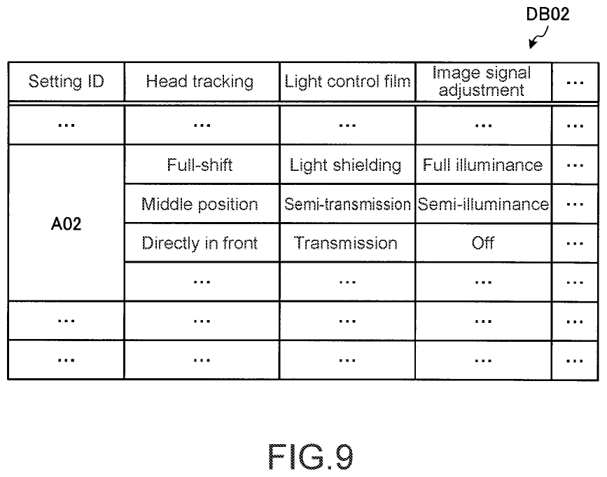

FIG. 9 illustrates an example of the data table DB02 according to the second embodiment. FIG. 9 is a diagram illustrating the example of the data table DB02 according to the second embodiment of the present disclosure. In the example illustrated in FIG. 9, the data table DB02 has items such as ┌setting ID┘, ┌head tracking┘, ┌light control film┘ and ┌image signal adjustment┘.

┌Setting ID┘ indicates identification information for identifying setting information. ┌Head tracking┘ indicates tracking information of the head of the user in the motion information of the user. For example, ┌Full-shift┘ of head tracking indicates the state of having moved (shifted) in the vertical direction or horizontal direction beyond the threshold value from the reference position (e.g., the installation position of the depth sensor 142 or direct front of the display section 250) for acquiring the position of the head. Further, ┌middle position┘ of head tracking indicates the state in which the head of the user is located in the middle area between the position directly in front of the reference position for acquiring the position of the head and the position determined to be ┌full-shift┘.

┌Light control film┘ indicates the transmissive state of the light control film 20. ┌Image signal adjustment┘ indicates setting information of the image signal projected from the projector 10. For example, ┌full-illuminance┘ of image signal adjustment indicates the state in which an image is projected from the projector 10 at the maximum luminance. Further, ┌semi-luminance┘ of image signal adjustment indicates the state in which an image is projected from the projector 10 with approximately half the luminance. Further, ┌off┘ of image signal adjustment indicates the state in which projection from the projector 10 is temporarily stopped.

That is, in the example illustrated in FIG. 9, as an example of setting information identified by setting ID ┌A02┘, it is shown that in the case where head tracking corresponds to ┌full-shift┘, the light control film is controlled to ┌light shielding┘ and the image signal is adjusted to full-luminance.

In other words, when the user greatly shifts the head from the front of the display section 250, the display section 250 transits to the light shielding state (black screen state illustrated in FIG. 6). In this state, since the luminance of the projector 10 is in a full-luminance state, the user can view a clear image. Further, when the user slightly shifts the head from the front of the display section 250, the display section 250 transits to the semi-light shielding state (mirror+screen state illustrated in FIG. 6). In this state, since the luminance of the projector 10 is in a semi-luminance state, the user can check his/her appearance on the mirror as well as view the image. In this case, since the display control apparatus 200 can provide the user with both the real image reflected on the mirror and the image content, it is possible to provide the user with an augmented reality (AR) experience. Further, when the user shifts the head to the front of the display section 250, the display section 250 transits to the transmissive state (mirror state illustrated in FIG. 6). In this state, since the projector 10 is turned off, the user can user the display section 250 as a mirror.

Returning to FIG. 7, the description will be continued. The acquisition section 132 according to the second embodiment acquires environment information around the display section 250 further including the light control mirror 40 having a variable transmittance via the illuminance sensor 141, etc.

Further, the acquisition section 132 acquires tracking information of the head of the user as information regarding motion of the user.

Specifically, the acquisition section 132 acquires, as tracking information of the head of the user, a relative positional relationship between the user facing the display section 250 and the display section 250. For example, the acquisition section 132 determines, in the case where the user is located within an angle (e.g., plus or minus 10 degrees) determined to be facing the display section 250 of the angle of view in which the depth sensor 142 can detect an object, that the user is facing the display section 250. Alternatively, the acquisition section 132 determines, in the case where the user is located within an angle (e.g., close to limitation of the angle of view in which the depth sensor 142 can detect an object) determined to be largely deviated of the angle of view in which the depth sensor 142 can detect an object, that the user is not facing the display section 250 and is located at a deviated position. In addition, the acquisition section 132 determines that the user is located at a position between a position facing the display section 250 and a position determined to be largely deviated.

Further, the display controller 133 according to the second embodiment controls at least of the pixel information of the image to be projected on the transparent screen 30, the transmittance of the light control film 20, or the transmittance of the light control mirror 40 on the basis of the environment information. For example, as in the example illustrated in FIG. 6, the display controller 133 may simultaneously change all the transmittances of the light control film 20 and the light control mirror 40, and may fix the light control mirror 40 in the mirror state and change only the transmittance of the light control film 20.

Further, the display controller 133 may control, on the basis of the information regarding motion of the user, the pixel information of the image to be projected on the transparent screen 30 and the transmittance of the light control film 20.

For example, the display controller 133 controls, on the basis of tracking information of the head of the user, the pixel information of the image to be projected on the transparent screen 30 and the transmittance of the light control film 20. Further, the display controller 133 may control the transmittance of the light control mirror 40 on the basis of the tracking information of the head of the user.

Specifically, the display controller 133 controls, on the basis of the relative positional relationship between the user and the display section 250, the pixel information of the image to be projected on the transparent screen 30 and the transmittance of the light control film 20.

As an example, the display controller 133 may perform a control operation such that the transmittance of the light control film 20 is lowered as the user approaches the position facing the display section 250 in the relative positional relationship between the user and the display section 250. Alternatively, the display controller 133 may perform a control operation such that the transmittance of the light control film 20 is increased as the user moves away from the position facing the display section 250 in the relative positional relationship between the user and the display section 250.

### 2-3. Procedure of Display Control Processing According to Second Embodiment

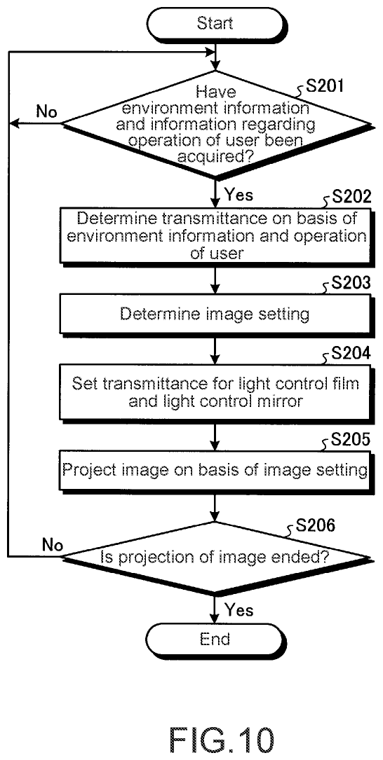

Next, procedure of information processing according to the second embodiment will be described using FIG. 10. FIG. 10 is a flowchart illustrating a flow of processing according to the second embodiment of the present disclosure.

As illustrated in FIG. 10, the display control apparatus 200 determines whether or not environment information and information regarding motion of a user have been acquired (Step S201). In the case where environment information and information regarding motion of a user have not been acquired (step S201; No), the display control apparatus 200 controls the sensor 140, and repeats processing for acquiring environment information and information regarding motion of a user.

In the case where environment information and information regarding motion of a user have been acquired (step S201; Yes), the display control apparatus 200 determines the transmittances of the light control film 20 and the light control mirror 40 on the basis of the environment information and the information regarding the motion of the user (step S202).

Further, the display control apparatus 200 determines, on the basis of the environment information and the information regarding the motion of the user, setting of the image signal output from the projector 10 (step S203).

Subsequently, the display control apparatus 200 sets the transmittances determined in step S102 for the light control film 20 and the light control mirror 40 (Step S204). Specifically, the display control apparatus 200 causes transition of the transmittance of the light control film 20 by controlling the light control film 20 on the basis of a parameter (voltage value or the like) for changing the transmittance of the light control film 20 to the transmittance determined in step S202. Further, the display control apparatus 200 causes transition of the transmittance of the light control mirror 40 by controlling the light control mirror 40 on the basis of a parameter (voltage value or the like) for changing the transmittance of the light control mirror 40 to the transmittance determined in step S202.

Further, the display control apparatus 200 projects an image on the display section 250 on the basis of the image setting by controlling the projector 10 with the image setting determined in step S203 (step S205). Alternatively, the display control apparatus 200 temporarily stops the projection of the image from the projector 10 on the basis of the image setting.

After that, the display control apparatus 200 determines whether or not an operation to end projection of the image has been received from the user (Step S206). In the case where the operation to end projection of the image has not been received from the user (Step S206; No), the display control apparatus 200 repeats a process of acquiring environment information and information regarding motion of a user, and continues adjusting the transmittance and image setting to obtain appropriate image display in accordance with the acquired information. Meanwhile, in the case where the operation to end projection of the image has been received from the user (step S206; Yes), the display control apparatus 200 ends projection of the image. For example, the display control apparatus 200 controls the light control film 20 so that the light control film 20 is transmissive and is made function as a normal mirror.

### 2-4. Modification According to Second Embodiment

The display control apparatus 200 according to the second embodiment may include a normal mirror instead of the light control mirror 40. Even when such a configuration is adopted, the display control apparatus 200 can arbitrarily change the state of the display section 250 to a state other than the transparent screen state illustrated in FIG. 6.

### 3. Other Embodiments

The processes according to the respective embodiments described above may be implemented in various different forms other than the respective embodiments.

### 3-1. One Example of Display Control System According to Present Disclosure

For example, the display control apparatus according to an embodiment of the present disclosure may correspond to an apparatus separated from the projector 10 or the display section 150 to control the separated projector 10 and display section 150. That is, the display control apparatus according to an embodiment of the present disclosure may correspond to an apparatus configured by combining the projector 10 and the display section 150, and control a display device that operates in a stand-alone manner. In addition, the display control apparatus according to an embodiment of the present disclosure may control a plurality of display devices.

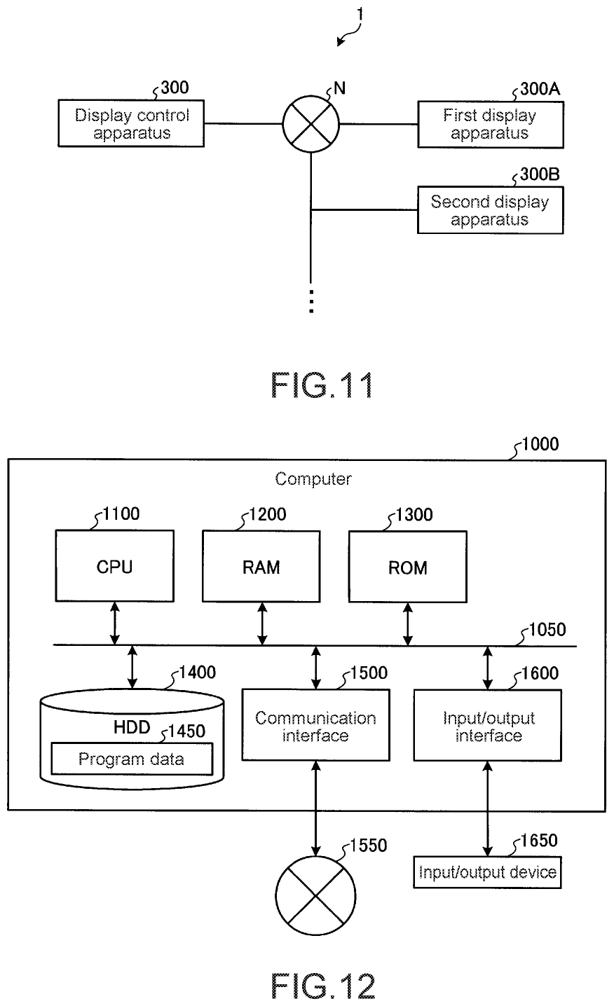

In this case, the display control processing according to an embodiment of the present disclosure may be executed by a display control system 1 illustrated in FIG. 11. FIG. 11 is a diagram illustrating a configuration example of the display control system 1 according to an embodiment of the present disclosure. As illustrated in FIG. 11, the display control system 1 includes a display control apparatus 300, and a first display apparatus 300A or a second display apparatus 300B. Note that the display control system 1 may include more display apparatuses.

In the display control system 1, the display control apparatus 300 collectively controls the transmittance of each display apparatus and an image signal on the basis of the illuminance sensor and the depth sensor provided in the vicinity of each of the first display apparatus 300A and the second display apparatus 300B.

In accordance with the display control system 1, since a plurality of display apparatuses can be controlled, for example, when the display apparatuses correspond to a plurality of digital signage, etc. simultaneously displaying the same content, it is possible to perform optimum display in accordance with each environment.

### 3-2. Other

For example, among the respective processes described in the respective embodiments, all or some of processes described as being automatically performed may be manually performed, or all or some of processes described as being manually performed may be automatically performed by a known method. In addition, a processing procedure, a specific name, and information including various data and parameters shown in the above-mentioned document and drawings can be arbitrarily changed unless otherwise specified. For example, various types of information shown in each figure are not limited to the illustrated information.

In addition, each component of each device illustrated in the figure is functionally conceptual, and does not necessarily need to be physically configured as illustrated in the figure. That is, a specific form of dispersion and integration of each device is not limited to the illustrated one, and all or some thereof may be functionally or physically dispersed/integrated in an arbitrary unit in accordance with various loads, usage conditions, etc.

In addition, the respective embodiments and modifications described above may be appropriately combined in a range not contradicting process content.

In addition, effects described in the present specification are merely examples and are not limited, and other effects may be present.

### 4. Effect of Display Control Apparatus According to Present Disclosure

As described above, the display control apparatus (the display control apparatus 100, etc. in the embodiments) according to an embodiment of the present disclosure includes the acquisition section (the acquisition section 132 in the embodiment) and the display controller (the display controller 133 in the embodiment). The acquisition section acquires the environment information around the display section (the display section 150, etc. in the embodiment) including the transparent screen which reflects the image projected from the projector and the light control film having a variable transmittance. The display controller controls the pixel information of the image to be projected on the transparent screen and the transmittance of the light control film on the basis of the environment information.

As described above, the display control apparatus according to an embodiment of the present disclosure can display an appropriate image under various environments by controlling the pixel information of the image and the transmittance of the light control film on the basis of the environment information. Further, the display control apparatus can prevent a user from feeling a sense of oppression, by using the transparent screen as the display section. As a result, the display control apparatus can realize image display that does not cause a user to feel a sense of oppression while ensuring visibility of an image under external light.

Further, the acquisition section acquires the illuminance around the display section. The display controller controls, on the basis of the illuminance, the pixel information of the image to be projected on the transparent screen and the transmittance of the light control film. As a result, the display control apparatus can perform appropriate display in accordance with the illuminance at a timing to display an image.

Further, the display controller controls the pixel information of the image and the transmittance of the light control film on the basis of the setting information in which the illuminance, the pixel information of the image, and the transmittance of the light control film are associated with each other in advance. As a result, the display control apparatus can control the display of the image on the basis of preset optimum setting, setting desired by the user, etc.

Further, the display controller performs a control operation such that the transmittance of the light control film is lowered and the luminance value of the pixel of the image is increased as the illuminance is higher. As a result, the display control apparatus can appropriate display in accordance with the current illuminance even if there is no information such as a preset illuminance and transmittance (the data table DB01 or the like).

Further, the acquisition section acquires environment information around the display section further including the light control mirror having a variable transmittance. The display controller controls, on the basis of the environment information, at least any of the pixel information of the image to be projected on the transparent screen, the transmittance of the light control film, and the transmittance of the light control mirror. As a result, the display control apparatus can provide the user with a fresh image experience by, for example, display a superimposed image on the mirror.

Further, the acquisition section acquires the information regarding the motion of the user around the display section. The display controller controls, on the basis of the information regarding the motion of the user, the pixel information of the image to be projected on the transparent screen and the transmittance of the light control film. As a result, the display control apparatus can selectively use the display section in accordance with the motion of the user, e.g., use the display section as a normal mirror or use the display section as an image screen.

Further, the acquisition section acquires, as the information regarding the motion of the user, tracking information of the head of the user. The display controller controls, on the basis of the tracking information of the head of the user, the pixel information of the image to be projected on the transparent screen and the transmittance of the light control film. As a result, the display control apparatus can switch the image or the mirror in accordance with the motion of the user without causing the user to perform a troublesome operation.

Further, the acquisition section acquires the relative positional relationship between the user facing the display section and the display section. The display controller controls, on the basis of the relative positional relationship between the user and the display section, the pixel information of the image to be projected on the transparent screen and the transmittance of the light control film. As a result, the display control apparatus can perform AR-like image display, e.g., display an image when the user is deviated from the display section or display an image and a semi-transmissive mirror.

Further, the display controller performs a control operation such that the transmittance of the light control film is lowered as the user approaches the position facing the display section in the relative positional relationship between the user and the display section. As a result, since the display control apparatus can cause the user to use the display section as a mirror when the user is facing the display section, it is possible to improve the convenience of the user.

### 5. Hardware Configuration

For example, information-processing equipment such as the display control apparatus 100 according to each embodiment described above is realized by a computer 1000 configured as illustrated in FIG. 12. Hereinafter, the display control apparatus 100 according to the first embodiment will be described as an example. FIG. 12 is a hardware configuration diagram illustrating an example of the computer 1000 for realizing a function of the display control apparatus 100. The computer 1000 includes a CPU 1100, a RAM 1200, a read only memory (ROM) 1300, a hard disk drive (HDD) 1400, a communication interface 1500, and an input/output interface 1600. Each section of the computer 1000 is connected by a bus 1050.

The CPU 1100 operates on the basis of a program stored in the ROM 1300 or the HDD 1400 to control each section. For example, the CPU 1100 loads a program stored in the ROM 1300 or the HDD 1400 into the RAM 1200 and executes processing corresponding to various programs.

The ROM 1300 stores a boot program such as a basic input output system (BIOS) executed by the CPU 1100 when the computer 1000 starts up, and a program that depends on hardware of the computer 1000.

The HDD 1400 is a computer readable recording medium for non-temporarily recording a program executed by the CPU 1100, data used by the program, etc. Specifically, the HDD 1400 is a recording medium for recording a display control program according to an embodiment of the present disclosure, which is an example of the program data 1450.

The communication interface 1500 is an interface for connecting the computer 1000 to an external network 1550 (for example, the Internet). For example, the CPU 1100 receives data from another device via the communication interface 1500, and transmits data generated by the CPU 1100 to another device.

The input/output interface 1600 is an interface for connecting the input/output device 1650 and the computer 1000 to each other. For example, the CPU 1100 receives data from an input device such as a keyboard and a mouse via the input/output interface 1600. In addition, the CPU 1100 transmits data to an output device such as a display and a speaker via the input/output interface 1600. In addition, the input/output interface 1600 may function as a media interface for reading a program, etc. recorded on a predetermined recording medium (media). Examples of the media include an optical recording medium such as a digital versatile disc (DVD) and a phase change rewritable disk (PD), a magneto-optical recording medium such as a magneto-optical disk (MO), a tape medium, a magnetic recording medium, and a semiconductor memory.

For example, when the computer 1000 functions as the display control apparatus 100 according to an embodiment of the present disclosure, the CPU 1100 of the computer 1000 implements a function of the control section 130, etc. by executing the display control program loaded on the RAM 1200. In addition, the HDD 1400 stores the display control program according to an embodiment of the present disclosure and data in the storage section 120. Note that even though the CPU 1100 reads the program data 1450 from the HDD 1400 and executes the program data 1450, these programs may be acquired from another device via the external network 1550 as another example.

Note that the present technology can be configured as follows.

(1)

A display control apparatus, including:
an acquisition section that acquires environment information around a display section, the display section including a transparent screen and a light control film, the transparent screen reflecting an image projected from a projector, the light control film having a variable transmittance; and
a display controller that controls, on a basis of the environment information, pixel information of an image to be projected on the transparent screen and a transmittance of the light control film.

(2)

The display control apparatus according to (1) above, in which
the acquisition section acquires an illuminance around the display unit, and
the display controller controls, on a basis of the illuminance, the pixel information of the image to be projected on the transparent screen and the transmittance of the light control film.

(3)

The display control apparatus according to any one of (1) or (2) above, in which
the display controller controls, on a basis of setting information in which the illuminance, the pixel information of the image, and the transmittance of the light control film are associated with each other in advance, the pixel information of the image and the transmittance of the light control film.

(4)

The display control apparatus according to any one of (1) to (3) above, in which
the display controller performs a control operation such that the transmittance of the light control film is lowered and a luminance value of a pixel of the image is increased as the illuminance is higher.

(5)

The display control apparatus according to any one of (1) to (4) above, in which
the acquisition section acquires environment information around the display section that further includes a light control mirror having a variable transmittance, and
the display controller controls, on a basis of the environment information, at least any of the pixel information of the image to be projected on the transparent screen, the transmittance of the light control film, and a transmittance of the light control mirror.

(6)

The display control apparatus according to any one of (1) to (5) above, in which
the acquisition section acquires information regarding motion of a user around the display unit, and
the display controller controls, on a basis of the information regarding the motion of the user, the pixel information of the image to be projected on the transparent screen and the transmittance of the light control film.

(7)

The display control apparatus according to any one of (1) to (6) above, in which
the acquisition section acquires, as the information regarding the motion of the user, tracking information of a head of the user, and
the display controller controls, on the basis of the tracking information of the head of the user, the pixel information of the image to be projected on the transparent screen and the transmittance of the light control film.

(8)

The display control apparatus according to any one of (1) to (7) above, in which
the acquisition section acquires a relative positional relationship between a user facing the display unit and the display section, and
the display controller controls, on a basis of the relative positional relationship between the user and the display unit, the pixel information of the image to be projected on the transparent screen and the transmittance of the light control film.

(9)

The display control apparatus according to any one of (1) to (8) above, in which
the display controller performs a control operation such that the transmittance of the light control film is lowered as the user moves away from a position facing the display section in the relative positional relationship between the user and the display section.

(10) A display control method, including: by a computer,
acquiring environment information around a display section, the display section including a transparent screen and a light control film, the transparent screen reflecting an image projected from a projector, the light control film having a variable transmittance; and
controlling, on a basis of the environment information, pixel information of an image to be projected on the transparent screen and a transmittance of the light control film.

(11)

A display control program that causes a computer to function as:
an acquisition section that acquires environment information around a display section, the display section including a transparent screen and a light control film, the transparent screen reflecting an image projected from a projector, the light control film having a variable transmittance; and
a display controller that controls, on a basis of the environment information, pixel information of an image to be projected on the transparent screen and a transmittance of the light control film.

(12)

An apparatus including:
circuitry configured to:
   control a transmissivity of a transparent screen and a brightness an image projected on the transparent screen, based on characteristics of an environment proximate to the transparent screen.

(13)

The apparatus according to (12), wherein the circuitry is further configured to:
acquire environment information associated with the environment; and
control the transmissivity of the transparent screen and the brightness of the image based on the acquired environment information.

(14)

The apparatus according to any one of (12) or (13), wherein the circuitry is further configured to:
control the brightness of the projected image by controlling pixel information of the projected image.

(15)

The apparatus according to any one of (12) to (14), wherein the environment information includes a numerical value of an illuminance of the environment proximate to the apparatus.

(16)

The apparatus according to any one of (12) to (15), wherein the circuitry is further configured to:
control the brightness of the projected image to be a first level based on the illuminance being a second level; and
control the brightness of the projected image to be a third level based on the illuminance being a fourth level,
wherein the first level is higher than the third level and the second level is higher than the fourth level.

(17)

The apparatus according to any one of (12) to (16), wherein the circuitry is further configured to:
control the transmissivity of the transparent screen to be a first level based on the illuminance being a second level; and
control the transmissivity of the transparent screen to be a third level based on the illuminance being a fourth level,
wherein the first level is lower than the third level and the second level is higher than the fourth level.

(18)

The apparatus according to any one of (12) to (17), wherein the circuitry is further configured to:
acquire position information of a relative positional relationship between a user and the transparent screen;
determine whether the user is directly facing the transparent screen or obliquely facing the transparent screen based on the acquired position information; and
control the transmissivity of the transparent screen, a transmissivity of a light control mirror, or the brightness of the projected image, based on the determination.

(19)

The apparatus according to any one of (12) to (18), wherein the circuitry is further configured to:
acquire motion information of a motion of a user.

(20)

The apparatus according to any one of (12) to (19), wherein the circuitry is further configured to:
control the transmissivity of the transparent screen, a transmissivity of a light control mirror, or the brightness of the projected image, based on the acquired motion information.

(21)

The apparatus according to any one of (12) to (20), wherein the light control mirror can switch between a mirror state and a transparent state.

(22)

The apparatus according to any one of (12) to (21), wherein the circuitry is further configured to:
determine whether the user is directly facing the transparent screen or obliquely facing the transparent screen based on the acquired motion information;
control the light control mirror to be in the mirror state based on a determination that the user is directly facing the transparent screen; and
control the light control mirror to be in a transparent state based on a determination that the user is obliquely facing the transparent screen.

(23)

The apparatus according to any one of (12) to (22), wherein the circuitry is further configured to:
determine whether the user is directly facing the transparent screen or obliquely facing the transparent screen based on the acquired motion information; and
control the transmissivity of the transparent screen, a transmissivity of a light control mirror, or the brightness of the projected image, based on the determination.

(24)

The apparatus according to any one of (12) to (23), wherein the circuitry is further configured to:
control the brightness of the projected image to be a first level based on a determination that the user is directly facing the transparent screen; and
control the brightness of the projected image to be a second level higher than the first level based on a determination that the user is obliquely facing the transparent screen.

(25)

The apparatus according to any one of (12) to (24), wherein the circuitry is further configured to:
control the transmissivity of the transparent screen to be a first level based on a determination that the user is directly facing the transparent screen; and
control the transmissivity of the transparent screen to be a second level higher than the first level based on a determination that the user is obliquely facing the transparent screen.

(26)

The apparatus according to any one of (12) to (25), wherein the circuitry is further configured to:
control the transmissivity of the light control mirror to be a first level based on a determination that the user is directly facing the transparent screen; and
control the transmissivity of the light control mirror to be a second level higher than the first level based on a determination that the user is obliquely facing the transparent screen.

(27)

The apparatus according to any one of (12) to (26), wherein the circuitry is further configured to:
determine whether a head of the user is moving sideways with respect to the transparent screen or upward/downward with respect to the transparent screen; and
control the transmissivity of the transparent screen or the brightness of the projected image based on the determination.

(28)

The apparatus according to any one of (12) to (27), wherein the circuitry is further configured to:
control the brightness of the projected image to be a first level based on a determination that the head of the user is moving upward/downward; and
control the brightness of the projected image to be a second level lower than the first level, based on a determination that the head of the user is moving sideways.

(29)

The apparatus according to any one of (12) to (28), wherein the circuitry is further configured to:
control the transmissivity of the transparent screen to be a first level based on a determination that the head of the user is moving upward/downward; and
control the transmissivity of the transparent screen to be a second level higher than the first level based on a determination that the head of the user is moving sideways.

(30)

A method including:
controlling a transmissivity of a transparent screen and a brightness of an image projected on the transparent screen, based on characteristics of an environment proximate to the transparent screen.

(31)

A non-transitory computer-readable medium having embodied thereon a program, which when executed by a computer causes the computer to execute a method, the method including:
controlling a transmissivity of a transparent screen and a brightness of an image projected on the transparent screen, based on characteristics of an environment proximate to the transparent screen.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

10 Projector
20 Light control film
30 Transparent screen
40 Light control mirror
60 Speaker
100, 200, 300 Display control apparatus
110 Communication section
120, 220 Storage section
130 Control section
131 Detector
132 Acquisition section
133 Display controller
134 Light control section
140 Sensor
150, 250 Display section
160 Output section

1. An apparatus comprising:
circuitry configured to:
control a transmissivity of a transparent screen and a brightness an image projected on the transparent screen, based on characteristics of an environment proximate to the transparent screen.

2. The apparatus of claim 1, wherein the circuitry is further configured to:
acquire environment information associated with the environment; and
control the transmissivity of the transparent screen and the brightness of the image based on the acquired environment information.

3. The apparatus of claim 1, wherein the circuitry is further configured to:
control the brightness of the projected image by controlling pixel information of the projected image.

4. The apparatus of claim 2, wherein the environment information includes a numerical value of an illuminance of the environment proximate to the apparatus.

5. The apparatus of claim 4, wherein the circuitry is further configured to:
control the brightness of the projected image to be a first level based on the illuminance being a second level; and
control the brightness of the projected image to be a third level based on the illuminance being a fourth level,
wherein the first level is higher than the third level and the second level is higher than the fourth level.

6. The apparatus of claim 4, wherein the circuitry is further configured to:
control the transmissivity of the transparent screen to be a first level based on the illuminance being a second level; and
control the transmissivity of the transparent screen to be a third level based on the illuminance being a fourth level,
wherein the first level is lower than the third level and the second level is higher than the fourth level.

7. The apparatus of claim 1, wherein the circuitry is further configured to:
acquire position information of a relative positional relationship between a user and the transparent screen;
determine whether the user is directly facing the transparent screen or obliquely facing the transparent screen based on the acquired position information; and
control the transmissivity of the transparent screen, a transmissivity of a light control mirror, or the brightness of the projected image, based on the determination.

8. The apparatus of claim 1, wherein the circuitry is further configured to:
acquire motion information of a motion of a user.

9. The apparatus of claim 8, wherein the circuitry is further configured to:
control the transmissivity of the transparent screen, a transmissivity of a light control mirror, or the brightness of the projected image, based on the acquired motion information.

10. The apparatus of claim 9, wherein the light control mirror can switch between a mirror state and a transparent state.

11. The apparatus of claim 10, wherein the circuitry is further configured to:
determine whether the user is directly facing the transparent screen or obliquely facing the transparent screen based on the acquired motion information;
control the light control mirror to be in the mirror state based on a determination that the user is directly facing the transparent screen; and
control the light control mirror to be in a transparent state based on a determination that the user is obliquely facing the transparent screen.

12. The apparatus of claim 8, wherein the circuitry is further configured to:
determine whether the user is directly facing the transparent screen or obliquely facing the transparent screen based on the acquired motion information; and
control the transmissivity of the transparent screen, a transmissivity of a light control mirror, or the brightness of the projected image, based on the determination.

13. The apparatus of claim 12, wherein the circuitry is further configured to:
control the brightness of the projected image to be a first level based on a determination that the user is directly facing the transparent screen; and
control the brightness of the projected image to be a second level higher than the first level based on a determination that the user is obliquely facing the transparent screen.

14. The apparatus of claim 12, wherein the circuitry is further configured to:
control the transmissivity of the transparent screen to be a first level based on a determination that the user is directly facing the transparent screen; and
control the transmissivity of the transparent screen to be a second level higher than the first level based on a determination that the user is obliquely facing the transparent screen.

15. The apparatus of claim 12, wherein the circuitry is further configured to:
control the transmissivity of the light control mirror to be a first level based on a determination that the user is directly facing the transparent screen; and
control the transmissivity of the light control mirror to be a second level higher than the first level based on a determination that the user is obliquely facing the transparent screen.

16. The apparatus of claim 8, wherein the circuitry is further configured to:
determine whether a head of the user is moving sideways with respect to the transparent screen or upward/downward with respect to the transparent screen; and
control the transmissivity of the transparent screen or the brightness of the projected image based on the determination.

17. The apparatus of claim 16, wherein the circuitry is further configured to:
control the brightness of the projected image to be a first level based on a determination that the head of the user is moving upward/downward; and
control the brightness of the projected image to be a second level lower than the first level, based on a determination that the head of the user is moving sideways.

18. The apparatus of claim 16, wherein the circuitry is further configured to:
control the transmissivity of the transparent screen to be a first level based on a determination that the head of the user is moving upward/downward; and
control the transmissivity of the transparent screen to be a second level higher than the first level based on a determination that the head of the user is moving sideways.

19. A method comprising:
controlling a transmissivity of a transparent screen and a brightness of an image projected on the transparent screen, based on characteristics of an environment proximate to the transparent screen.

20. A non-transitory computer-readable medium having embodied thereon a program, which when executed by a computer causes the computer to execute a method, the method comprising:
controlling a transmissivity of a transparent screen and a brightness of an image projected on the transparent screen, based on characteristics of an environment proximate to the transparent screen.
